(19) United States
(12) Patent Application Publication
(10) Pub. No.: US 2016/0224455 A1
(43) Pub. Date: Aug. 4, 2016

(54) METHOD OF VERIFYING A SET OF TESTS, STORAGE MEDIUM, AND APPARATUS

(71) Applicant: FUJITSU LIMITED, Kawasaki-shi (JP)

(72) Inventors: Atsuji SEKIGUCHI, Kawasaki (JP); Yuuji HOTTA, Kawasaki (JP); Toshihiro SHIMIZU, Sagamihara (JP); Takeshi Yasuie, Kawasaki (JP)

(73) Assignee: FUJITSU LIMITED, Kawasaki-shi (JP)

(21) Appl. No.: 14/947,591

(22) Filed: Nov. 20, 2015

(30) Foreign Application Priority Data
Jan. 30, 2015 (JP) 2015-017315

(51) Int. Cl. G06F 11/36

(52) U.S. Cl. CPC G06F 11/3612; G06F 11/3684; G06F 11/3688; G06F 11/3692

(57) ABSTRACT

A verifying method includes: creating, for each of tests, combination in which information identifying the test, information identifying input data, and information identifying output data are associated with one another; specifying, when a first test is changed, second combination in which information identifying output data in first combination relating to the first test is set as the information identifying input data, the second combination relating to a second test; updating, in the first combination, the information identifying the corresponding test to first information identifying the changed first test; updating, in the first combination, the information identifying the output data to second information identifying output data output by verifying the changed first test; and updating the second combination, based on verifying the second test in which the information identifying input data in the second combination is set as the second information identifying the output data in the updated first combination.

### CROSS-REFERENCE TO RELATED APPLICATION

This application is based upon and claims the benefit of priority of the prior Japanese Patent Application No. 2015-017315, filed on Jan. 30, 2015, the entire contents of which are incorporated herein by reference.

### FIELD

The embodiments discussed herein are related to a method of verifying a set of tests, storage medium, and apparatus.

### BACKGROUND

Upon verifying whether a function implemented into a created application performs to specification, various tests based on a specification are executed. Examples of the tests include verification performed by executing one test. In addition, examples of the tests include verification performed by combining and executing tests, treating output data, output by a test, as input data for another test, and executing the other test.

In a case where tests are combined and successive tests are executed, it takes time to execute all the tests. Therefore, it is thought that the successive tests may be subdivided and executed. In a case where the successive tests are subdivided and executed, combination information obtained by combining information for identifying input data and information for identifying tests and output data may be registered in advance, and for each of the tests, it may be verified, by using the combination information, whether the output data is correct for the input data.

As examples of the related art, International Publication Pamphlet No. WO 2012/073686, Japanese Laid-open Patent Publication No. 2004-310279, and Japanese Laid-open Patent Publication No. 2010-123118 have been known.

### SUMMARY

According to an aspect of the invention, a method of verifying a set of tests in which the tests are successively executed, the method includes: creating, based on the set of tests, for each of the tests, combination information in which information for identifying the test, information for identifying input data, and information for identifying output data are associated with one another; specifying, when a first test out of the tests is changed, second combination information in which information for identifying output data in first combination information relating to the first test is set as the information for identifying input data, the second combination information relating to a second test out of the tests; updating, in the first combination information, the information for identifying the corresponding test to first information for identifying the changed first test; updating, in the first combination information, the information for identifying the output data to second information for identifying output data output by verifying the changed first test; and updating the second combination information, based on verifying the second test in which the information for identifying input data in the second combination information is set as the second information for identifying the output data in the updated first combination information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A, 1B, and 1C illustrate examples of a test set and an example of a subdivided test set;

FIGS. 2A, 2B, and 2C each illustrate a state in which a VM image or a container image is created using a VM or a container, respectively;

FIG. 3 illustrates a system configuration of a verification system;

FIG. 4 illustrates a hardware configuration of a verification device;

FIG. 5 illustrates an example of a test set table;

FIG. 6 illustrates an example of a combination information table;

FIG. 7 illustrates an example of a container image table;

FIG. 8 illustrates a functional configuration of a verification execution unit;

FIG. 9 is a sequence diagram of verification processing in the verification system;

FIG. 10 is a flowchart of preparation processing;

FIG. 11 is a flowchart of execution processing;

FIG. 12 is a flowchart of re-execution processing;

FIG. 13 illustrates an example of a test set table;

FIGS. 14A and 14B each illustrate a relationship between individual tests included in a test set;

FIGS. 15A, 15B, and 15C illustrate examples of the combination information table and the container image table;

FIGS. 16A, 16B, and 16C illustrate other examples of the combination information table and the container image table;

FIG. 17 illustrates a relationship between tests and images;

FIG. 18 illustrates an example of a changed test set table;

FIGS. 19A and 19B are diagrams for contrasting relationships between tests and images before and after a change with each other;

FIGS. 20A, 20B, and 20C illustrate other examples of the combination information table and the container image table; and

FIGS. 21A, 21B, and 21C illustrate yet other examples of the combination information table and the container image table.

### DESCRIPTION OF EMBODIMENTS

In a case where one test out of successive tests is changed or a specification is changed, output data changes depending on the changed test or specification, and another test is influenced thereby. On the other hand, in a case where the successive tests are subdivided, it is difficult to understand which test is influenced by a change in one test or a change in a specification. Therefore, it is difficult to update the combination information.

In one aspect of the present embodiment, in accordance with a modification in one test, combination information is updated while an influenced test is executed.

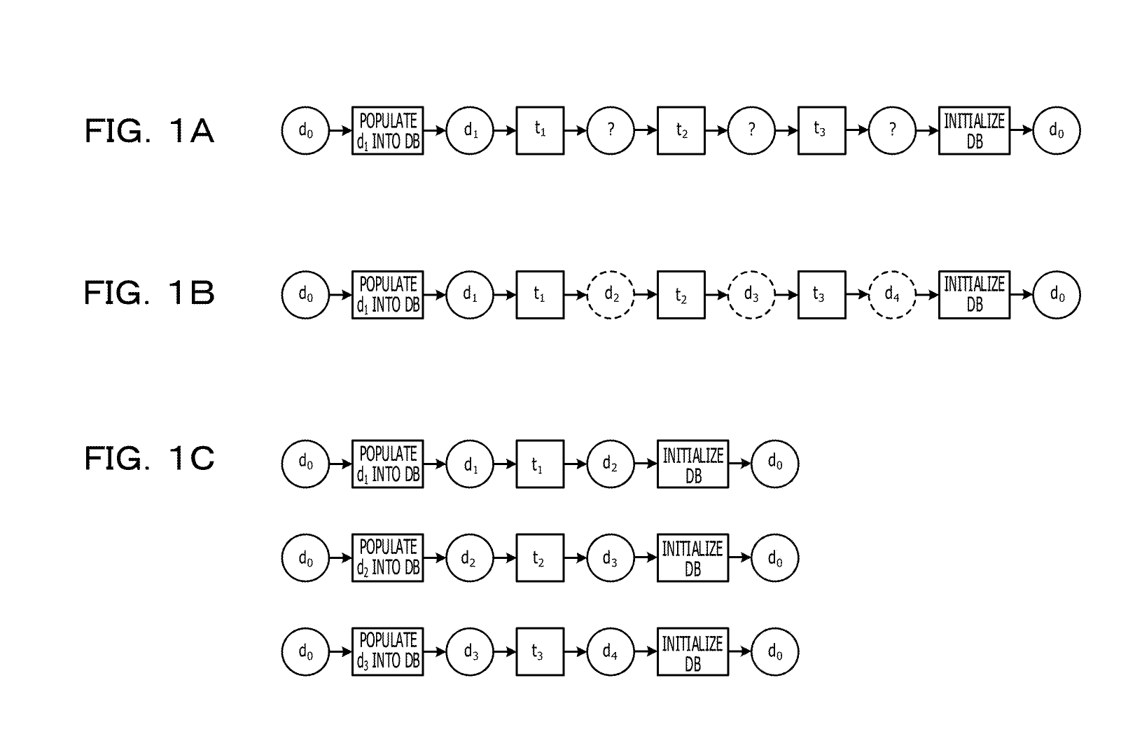

First, a verification method based on a verification device in an embodiment will be described. The verification device in an embodiment performs verification with a test set as a verification target. FIGS. 1A, 1B, and 1C illustrate examples of a test set and an example of a subdivided test set. Note that, in the drawings, circular graphics, into which alphanumeric characters are put, each indicate being data and quadrangular graphics, into which characters including alphanumeric characters are put, each indicate being an operation (including a test) for data.

A test set illustrated in FIG. 1A is a test set, in which three tests of t₁, t₂, and t₃ are successively executed, and indicates a state in which data within a database (hereinafter, abbreviated as DB) is in a state of d₀ (initialized state) and initial data d₁ is populated.

If, as illustrated in FIG. 1A, the initial data d₁ is populated into the DB, the test t₁ is executed with the populated initial data d₁ as input data, and the test t₂ is executed with a test result (output data) of the test t₁ as input data. Furthermore, the test t₃ is executed with a test result of the test t₂ as input data, and after a test result is output, the DB is initialized and the data within the DB is put into the state of d₀.

As illustrated in FIG. 1A, in the test set in which the tests are successively executed, each of the tests is executed with a test result of a test at a preceding stage as input data. Therefore, there is an advantage that it is possible to set, to one, the number of times the initial data (d₁) is populated into the DB and the DB is initialized.

On the other hand, in a case where, as illustrated in FIG. 1A, the tests are successively executed, data is not managed between the tests. Therefore, even in a case where some tests are changed, it is difficult to initiate execution from the changed tests, and it is desirable to initiate execution from an initial test out of the test set. In other words, it is desirable to execute wasted tests (individual tests located on preceding stage sides of the changed tests), and there is a disadvantage that it takes time to execute the tests.

In contrast, it is thought that, in order to enhance the independence of the tests, data between the tests may be managed as illustrated in FIG. 1B and furthermore the test set may be divided in units of tests as illustrated in FIG. 1C.

However, in a case where the test set is divided in units of tests as illustrated in FIG. 1C, it is desirable to populate initial data into the DB and to initialize the DB, and it takes time. In addition, in a case where some tests are changed and accordingly test results of the changed tests are different from test results of the tests before changes, it is desirable to execute all tests that are located at subsequent stages and in which pieces of input data thereof are different test results. In other words, in the tests located at the stages subsequent to the changed tests, it is desirable to populate input data into the DB, and there is a disadvantage that it takes time to execute the tests.

In consideration of such a state, the verification device in an embodiment utilizes a virtual machine (VM) image or a container image. The VM means a machine that virtually operates by virtually handling with pieces of hardware such as a CPU and a network, and the VM image means a file in which disk and memory contents and so forth, desirable for operating the VM, are collected.

In addition, the container means a machine that virtually operates at an operating system (OS) level without virtualizing at a hardware level in such a manner as the VM, and the container image means a file in which disk and memory contents, desirable for operating the container, are collected.

By creating the VM or the container, the verification device in an embodiment acquires input data and output data of each of tests as VM images or container images. In addition, pieces of information (image IDs) for identifying images of input data and output data acquired as VM images or container images are held as combination information while the pieces of information are associated with pieces of information (test IDs) for identifying tests.

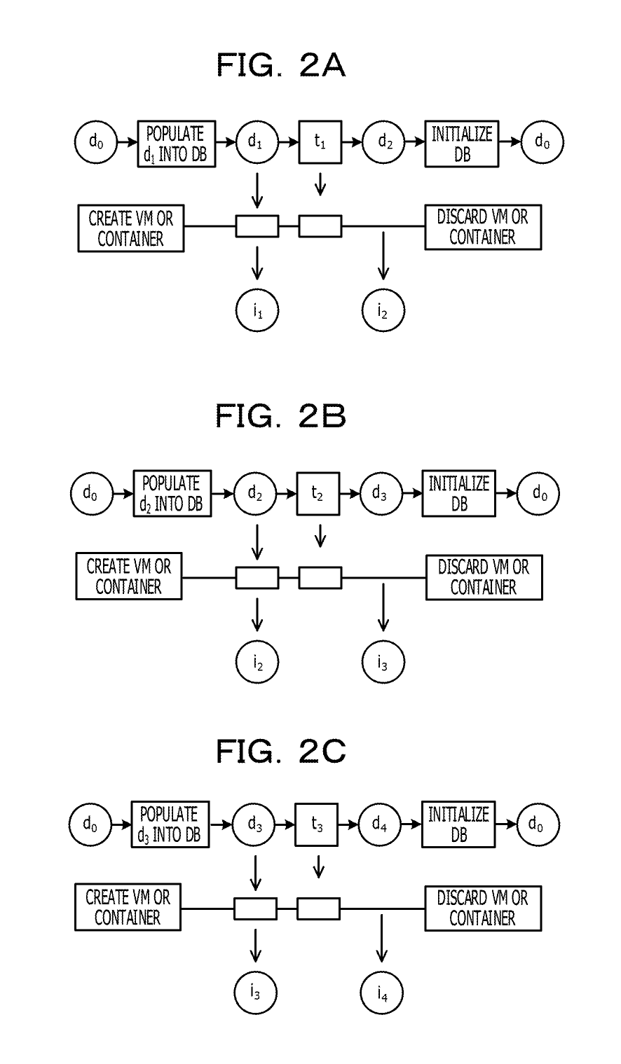

FIGS. 2A, 2B, and 2C each illustrate a state in which a VM image or a container image is created using a VM or a container, respectively. FIG. 2A illustrates a state in which a test in the upper stage of FIG. 1C is executed using a VM or a container.

As illustrated in FIG. 2A, after the VM or the container is created, input data d₁ to be populated into the DB is populated into the VM or the container, thereby acquiring a VM image or a container image (an image ID=“i₁”) including the input data d₁. In addition, a test identified by a test ID=“t₁” is executed using the VM or the container, and accordingly the data d₁ included in the image identified by the image ID=“i₁” is changed to data d₂. From this, in the VM or the container, an image (an image ID=“i₂”) including the data d₂ is acquired. After that, the VM or the container is discarded.

In the same way, FIG. 2B illustrates a state in which a test in the middle stage of FIG. 1C is executed using a VM or a container, and FIG. 2C illustrates a state in which a test in the lower stage of FIG. 1C is executed using a VM or a container. In the same way as in FIG. 2A, in cases of FIGS. 2B and 2C, images identified by image IDs=“i₂”, “i₃”, and “i₄” are acquired.

The verification device in an embodiment holds the images, acquired in this way, as the combination information along with the test IDs. From this, instead of populating input data into the DB at the time of executing each of the tests, a VM image or a container image including input data of each of the tests only has to be read from the combination information. In addition, instead of initializing the DB after executing each of the tests, a VM or a container used for each of the tests only has to be discarded.

In other words, according to the verification device in an embodiment, it becomes possible to save time taken to populate data into the DB and to initialize the DB, the independency of each of the tests in the test set is enhanced, and a test time is reduced.

In addition, according to the verification device in an embodiment, combination information for each of the tests is held, and accordingly combination information including a test influenced in a case where some tests are changed is extracted by searching a combination information table. In addition, by executing, based on the searched combination information, the influenced test, an input image and an output image are sequentially updated.

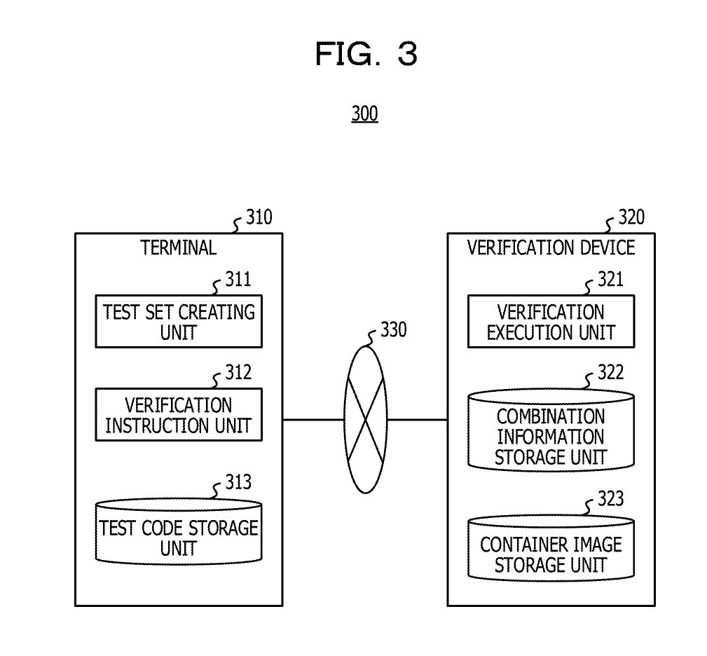

Hereinafter, more details of an embodiment will be described with reference to drawings in and after FIG. 3. Note that the same symbols are assigned to configuration elements having substantially the same functional configurations in the present specification and the drawings and redundant descriptions will be omitted.

### Embodiments

First, a verification system including the verification device in the present embodiment will be described. FIG. 3 illustrates a system configuration of the verification system. As illustrated in FIG. 3, a verification system 300 includes a terminal 310 and a verification device 320, and the terminal 310 and the verification device 320 are coupled to each other via a network 330.

The terminal 310 is an information processing device used by a user who creates a test set. A test set creating program and a verification instruction program are installed into the terminal 310, and by executing the individual programs, the terminal 310 functions as a test set creating unit 311 and a verification instruction unit 312.

The test set creating unit 311 creates a test set including tests to be successively executed and stores the created test set in a test code storage unit 313. The verification instruction unit 312 instructs the verification device 320 to execute verification of a test set selected by the user from among test sets stored in the test code storage unit 313.

The verification device 320 is a server device instructed to execute verification of the test set by the terminal 310. A verification program is install into the verification device 320, and by executing the verification program, the verification device 320 functions as a verification execution unit 321.

The verification execution unit 321 is instructed to execute the verification of the test set by the terminal 310. The verification of the test set includes a preparation phase for performing preparation before execution of individual tests included in the test set, an execution phase for executing the individual tests, and a re-execution phase for re-executing a changed test.

The verification execution unit 321 stores, in a combination information storage unit 322 and a container image storage unit 323, a combination information table and a container image table (the details thereof will be described later), respectively, created in the preparation phase. In addition, in the execution phase and the re-execution phase, the verification execution unit 321 executes tests by using these tables. The verification execution unit 321 transmits, to the terminal 310 as a verification result, test results of the individual tests included in the test set.

Next, hardware configurations of the terminal 310 and the verification device 320 will be described. Note that since the hardware configuration of the terminal 310 is nearly identical to the hardware configuration of the verification device 320, here the hardware configuration of the verification device 320 will be described.

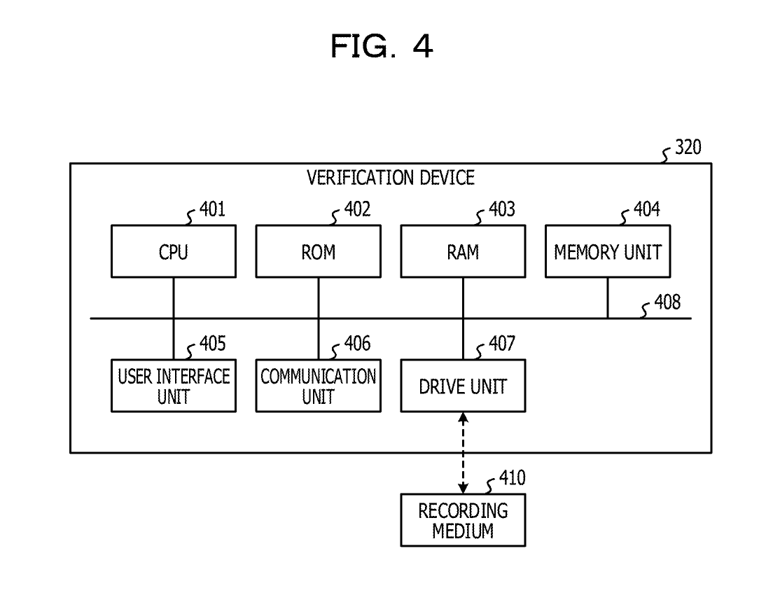

FIG. 4 illustrates a hardware configuration of a verification device. As illustrated in FIG. 4, the verification device 320 includes a CPU 401, a read only memory (ROM) 402, a random access memory (RAM) 403, and a memory unit 404. In addition, the verification device 320 includes a user interface unit 405, a communication unit 406, and a drive unit 407. Note that the individual units in the verification device 320 are coupled to one another via a bus 408.

The CPU 401 is a computer that executes various kinds of programs (for example, the verification program) stored in the memory unit 404.

The ROM 402 is a nonvolatile memory. The ROM 402 stores therein various kinds of programs, data, and so forth, desirable for execution of the various kinds of programs stored in the memory unit 404, performed by the CPU 401. The ROM 402 stores therein boot programs such as, for example, a basic input-output system (BIOS) and an extensible firmware interface (EFI).

The RAM 403 is a main memory device such as a dynamic random access memory (DRAM) or a static random access memory (SRAM). The RAM 403 functions as a working area into which the various kinds of programs stored in the memory unit 404 are loaded at the time being executed by the CPU 401.

The memory unit 404 includes a storage unit that stores therein data used at the time of execution of a program, data created by execution of a program, and so forth in addition to the various kinds of programs installed into the verification device 320. The storage unit included in the memory unit 404 includes, for example, the combination information storage unit 322 and the container image storage unit 323.

The user interface unit 405 receives various kinds of operations for the verification device 320. The communication unit 406 is used when the verification device 320 performs communication with the terminal 310.

A recording medium 410 is set on the drive unit 407. Examples of the recording medium 410 include a medium that optically, electrically, or magnetically records therein information in such a manner as in a CD-ROM, a flexible disk, or a magneto-optical disk. Alternatively, examples of the recording medium 410 include a semiconductor memory or the like, which electrically records therein information in such a manner as in a ROM, a flash memory, or the like.

Note that by setting, on the drive unit 407, various kinds of programs recorded in, for example, the distributed recording medium 410, the various kinds of programs (for example, the verification program) stored in the memory unit 404 may be installed into the memory unit 404. Alternatively, the various kinds of programs may be downloaded from the network 330 via the communication unit 406 and be installed into the memory unit 404.

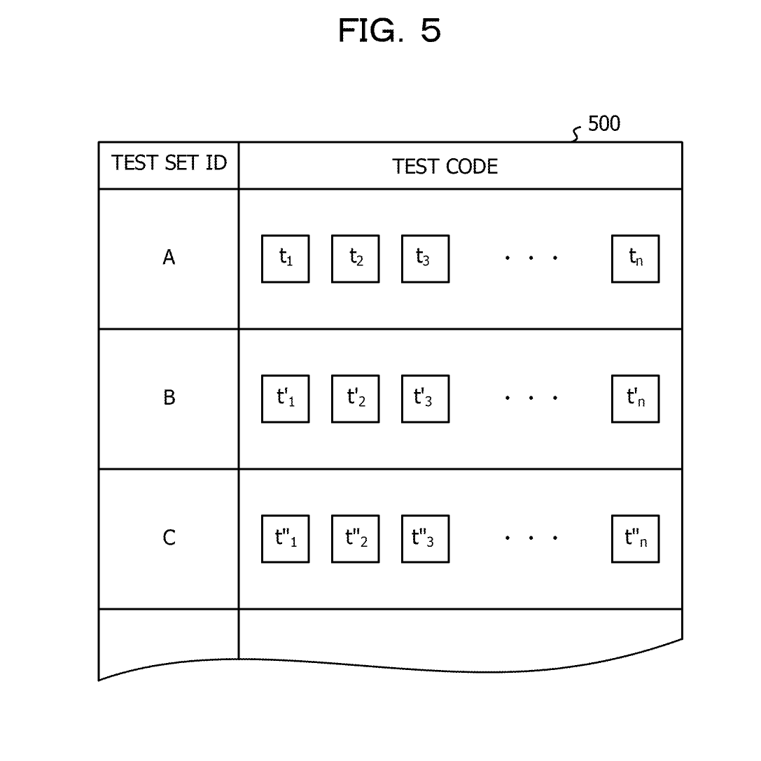

Next, a test set table stored in the test code storage unit 313 included in the terminal 310 will be described. FIG. 5 illustrates an example of the test set table. As illustrated in FIG. 5, as items of information, a test set table 500 includes a “test set ID” and a “test code”.

Identifiers each used for identifying a test set including tests to be successively executed are stored in the “test set ID”. Test codes of tests included in each of test sets are stored in the “test code”.

The example of FIG. 5 indicates that a test set identified by a test set ID=“A” includes tests identified by respective test IDs=“t₁”, “t₂”, “t₃”, . . . “tₙ”. In the same way, the example of FIG. 5 indicates that a test set identified by a test set ID=“B” includes tests identified by respective test IDs=“t′₁”, “t′₂”, “t′₃”, . . . “t′ₙ,”. Furthermore, the example of FIG. 5 indicates that a test set identified by a test set ID=“C” includes tests identified by respective test IDs=“t″₁”, “t″₂”, “t″₃”, . . . “t″ₙ”.

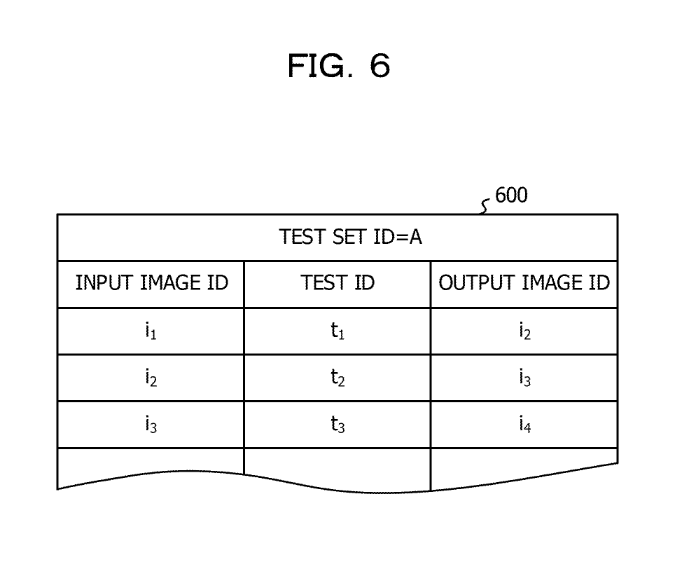

Next, a combination information table stored in the combination information storage unit 322 included in the verification device 320 will be described. FIG. 6 illustrates an example of a combination information table. As illustrated in FIG. 6, a combination information table 600 is managed for each of test set IDs (the example of FIG. 6 is the test set identified by the test set ID=“A”) and includes, as items of information, an “input image ID”, a “test ID”, and an “output image ID”.

Pieces of information (input image IDs) for identifying input images created by populating, into containers, pieces of input data to be input to respective tests included in the test set are stored in the “input image ID”. Test IDs of the respective tests included in the test set are stored in the “test ID”. Pieces of information (output image IDs) for identifying output images, output by containers executing, based on input images, the respective tests included in the test set, are stored in the “output image ID”.

In the example of FIG. 6, first combination information includes an input image ID=“i₁”, the test ID=“t₁”, and an output image ID=“i₂”. The first combination information indicates that an input image identified by the input image ID=“i₁” is input to the test identified by the test ID=“t₁”. In addition, the first combination information indicates that, by executing the test identified by the test ID=“t₁”, an output image identified by the output image ID=“i₂” is output.

In the same way, second combination information includes an input image ID=“i₂”, the test ID=“t₂”, and an output image ID=“i₃”. The second combination information indicates that an input image identified by the input image ID=“i₂” is input to the test identified by the test ID=“t₂”. In addition, the second combination information indicates that, by executing the test identified by the test ID=“t₂”, an output image identified by the output image ID=“i₃” is output.

In the same way, third combination information includes an input image ID=“i₃”, the test ID=“t₃”, and an output image ID=“i₄”. The third combination information indicates that an input image identified by the input image ID=“i₃” is input to the test identified by the test ID=“t₃”. In addition, the third combination information indicates that, by executing the test identified by the test ID=“t₃”, an output image identified by the output image ID=“i₄” is output.

In this way, the combination information table 600 includes pieces of combination information in each of which the image ID of an input image including input data, the image ID of an output image including output data, and a test ID are combined with one another. The combination information is created for every test included in the test set.

Note that since tests in which inputs and outputs of data are linked are included in a case of the test set ID=“A”, an output image of the test identified by, for example, the test ID=“t₁” becomes an input image of the test identified by the test ID=“t₂”. In the same way, an output image of the test identified by the test ID=“t₂” becomes an input image of the test identified by the test ID=“t₃”.

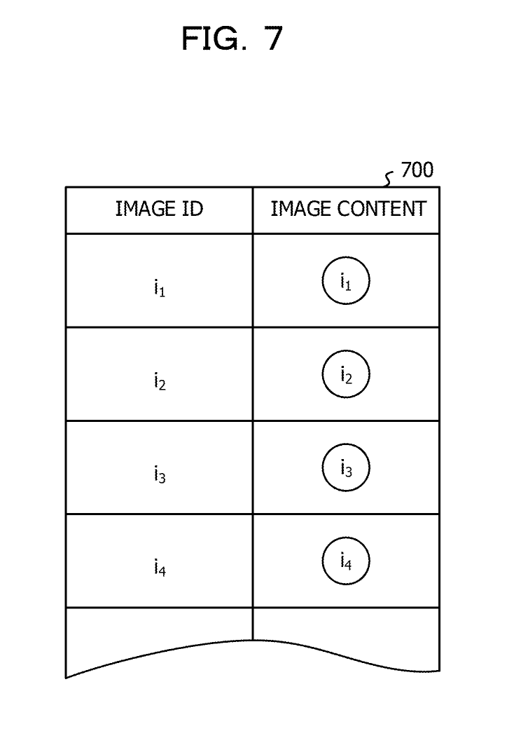

Next, container image information stored in the container image storage unit 323 included in the verification device 320 will be described. FIG. 7 illustrates an example of a container image table. As illustrated in FIG. 7, a container image table 700 includes, as items of information, an “image ID” and an “image content”.

An image ID of an output image created by a container executing a test, based on an image ID of an input image acquired by populating input data into the container or the input image, is stored in the “image ID”.

An image identified by the image ID is stored in the “image content” while being associated with the image ID.

In the example of FIG. 7, images individually identified by the image IDs=“i₁”, “i₂”, “iₛ”, and “i₄” are stored while being associated with the respective image IDs. In this way, the images identified by the image IDs are stored. Therefore, only by reading images from the container image table 700, it is possible to execute tests without populating input data into the DB.

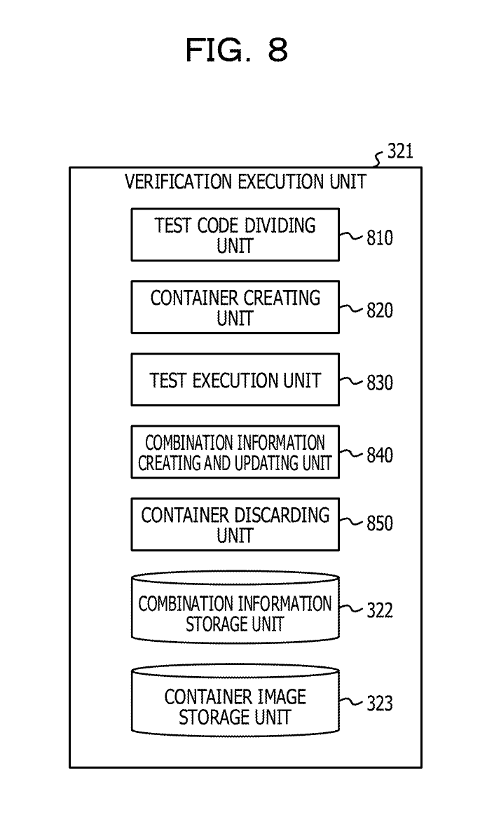

Next, a functional configuration of the verification execution unit 321 in the verification device 320 will be described. FIG. 8 illustrates a functional configuration of a verification execution unit.

As illustrated in FIG. 8, the verification execution unit 321 includes a test code dividing unit 810, a container creating unit 820, a test execution unit 830, a combination information creating and updating unit 840, and a container discarding unit 850.

In a case of receiving, in the preparation phase, a test set subjected to a verification instruction by the terminal 310, the test code dividing unit 810 divides the received test set into individual tests.

The container creating unit 820 creates a container at the time of executing a test in each of the phases.

Using the container created by the container creating unit 820 in each of the phases, the test execution unit 830 executes the test.

In, for example, the preparation phase, the test execution unit 830 populates input data into the container for each of the tests obtained by the test code dividing unit 810 dividing the test set, thereby creating an input image including the input data. In addition, the test execution unit 830 inputs the created input image to the container and executes the relevant test, thereby acquiring an output image including output data.

In addition, in the execution phase, for each of the tests obtained by the test code dividing unit 810 dividing the test set, the test execution unit 830 inputs, to the container, an input image read from the combination information storage unit 322, and executes the relevant test. From this, the test execution unit 830 acquires output data. In addition, the test execution unit 830 verifies whether the acquired output data is right or wrong, and the test execution unit 830 transmits a verification result to the terminal 310.

Furthermore, in the re-execution phase, for a changed teat, the test execution unit 830 inputs, to the container, an input image read from the combination information storage unit 322, thereby executing the changed test and acquiring output data. In addition, the test execution unit 830 verifies whether the acquired output data is right or wrong, and the test execution unit 830 transmits a verification result to the terminal 310. In addition, in the re-execution phase, in a case of determining that output data is right, the test execution unit 830 adds, to the container image storage unit 323, an output image including the output data and an image ID of the output image.

Furthermore, in the re-execution phase, the test execution unit 830 determines whether or not the output data acquired by executing the changed test is equal to output data acquired by executing the test before the change. In addition, in a case of determining that these pieces of output data are not equal to each other, the test execution unit 830 searches within the combination information table 600 in the combination information storage unit 322, thereby extracting combination information including a test whose input image is new output image including the output data. Furthermore, the test execution unit 830 executes the test, included in the extracted combination information, with the new output image as the input image, thereby acquiring output data, and verifies whether the output data is right or wrong. In addition, the test execution unit 830 transmits a verification result to the terminal 310. In a case of determining that the output data acquired at this time is right and the output data is not equal to output data acquired in the execution phase, the test execution unit 830 searches within the combination information table 600 in the combination information storage unit 322. From this, the combination information including the test whose input image is the new output image including the output data is extracted.

In the re-execution phase, the test execution unit 830 repeats such processing as described above until it is determined that output data is wrong or until it is determined that there is no test whose input image is an output image including output data.

The combination information creating and updating unit 840 creates combination information in which the image ID of an input image created at the time of the test execution unit 830 executing a test, the image ID of an output image acquired by executing the test, and a test ID are combined with one another. In addition, the combination information creating and updating unit 840 stores the created combination information in the combination information table 600.

In, for example, the preparation phase, for each of the tests obtained by the test code dividing unit 810 dividing the test set, the combination information creating and updating unit 840 creates and stores the corresponding combination information in the combination information table 600.

In addition, in the re-execution phase, the combination information creating and updating unit 840 updates the combination information table 600. In a case where it is determined that, for example, output data acquired by a changed test being executed is different from output data acquired in the execution phase and is right, the combination information creating and updating unit 840 updates the combination information table 600 by using the image ID of an output image including the output data.

In a case where tests executed by the test execution unit 830 finish, the container discarding unit 850 discards a container used for executing the tests.

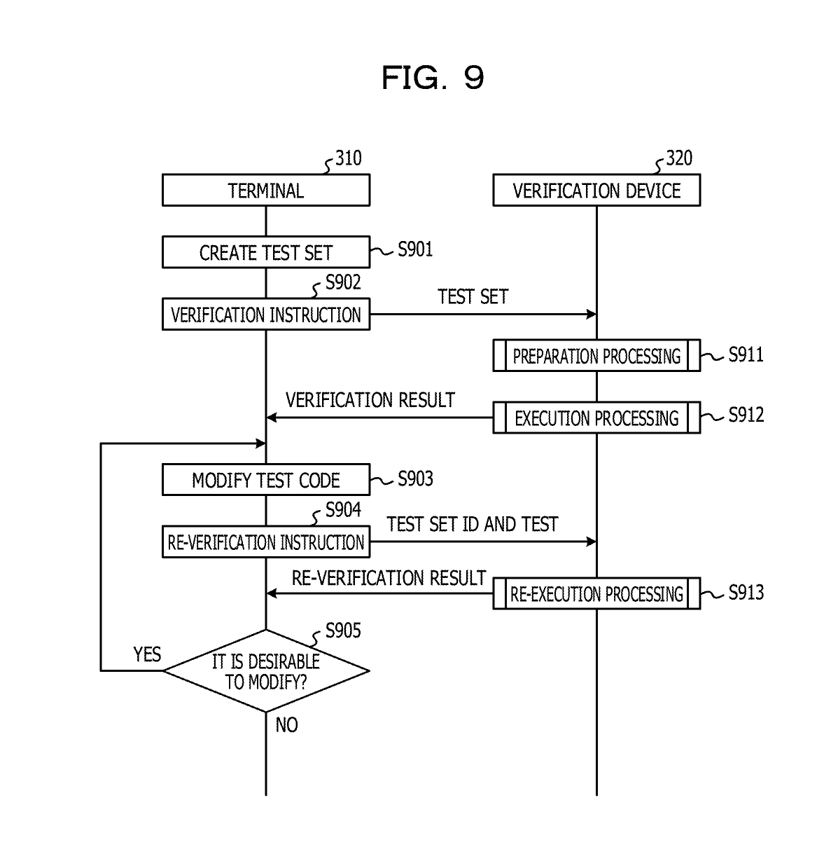

Next, a flow of verification processing in the verification system 300 will be described. FIG. 9 is a sequence diagram of verification processing in a verification system.

As illustrated in FIG. 9, if the test set creating program is executed in the terminal 310, in a step S901 a user of the terminal 310 creates tests by using a function of the test set creating unit 311 and creates a test set including the individual tests. The test set creating unit 311 stores, in the test code storage unit 313, the test set created by the user.

In addition, if the verification instruction program is executed in the terminal 310, in a step S902 the user of the terminal 310 selects a test set to serve as a verification target from the test code storage unit 313 by using a function of the verification instruction unit 312 and inputs a verification instruction. From this, the verification instruction unit 312 transmits, to the verification device 320, the verification instruction including the test set selected by the user.

Upon receiving the verification instruction from the terminal 310, the verification device 320, caused to function as the verification execution unit 321 by execution of the verification program, transitions to the preparation phase and executes the preparation processing in a step S911. From this, for the test set included in the verification instruction, the verification device 320 creates and stores the combination information table 600 and the container image table 700 in the combination information storage unit 322 and the container image storage unit 323, respectively. Note that details of the preparation processing in the step S911 will be described later.

The verification device 320 that completes the preparation processing transitions to the execution phase, and in a step S912, the verification device 320 executes the individual tests of the test set included in the verification instruction and executes execution processing for verifying whether output data is right or wrong. At this time, the verification device 320 utilizes the combination information table 600 and the container image table 700, created in the preparation processing in the step S911. In addition, the verification device 320 transmits, to the terminal 310, a verification result verified by the tests being executed in the execution processing (step S912). Note that details of the execution processing in the step S912 will be described later.

The terminal 310 receives, from the verification device 320, the verification result of the test set specified in the verification instruction. In a step S903, using a function of the test set creating unit 311, the user of the terminal 310 modifies a test code, based on the received verification result. A test whose test code is modified is stored in the test code storage unit 313.

In a step S904, using a function of the verification instruction unit 312, the user of the terminal 310 inputs, from the test code storage unit 313, a re-verification instruction including a test to serve as a verification target. From this, the verification instruction unit 312 transmits, to the verification device 320, the re-verification instruction including the changed test and the test set ID of a test set including the test.

Upon receiving the re-verification instruction from the terminal 310, the verification device 320 transitions to the re-execution phase and executes re-execution processing in a step S913. From this, the verification device 320 executes the test included in the re-verification instruction. In addition, by executing the test included in the re-verification instruction, the test desired to be re-executed is re-executed.

The verification device 320 transmits, to the terminal 310, a re-verification result obtained by the test being re-executed in the re-execution processing (step S913). Note that details of the re-execution processing in the step S913 will be described later.

The user of the terminal 310 that receives, from the verification device 320, the verification result of the test set including the test subjected to the re-verification instruction determines whether or not it is desirable to modify a test code again, and in a case of determining that it is desirable to modify the test code, the processing returns to the step S903. From this, the processing operations in the step S903, the step S904, and the step S913 are repeated. On the other hand, in a case where it is not determined that it is desirable to modify the test code, the verification processing is terminated.

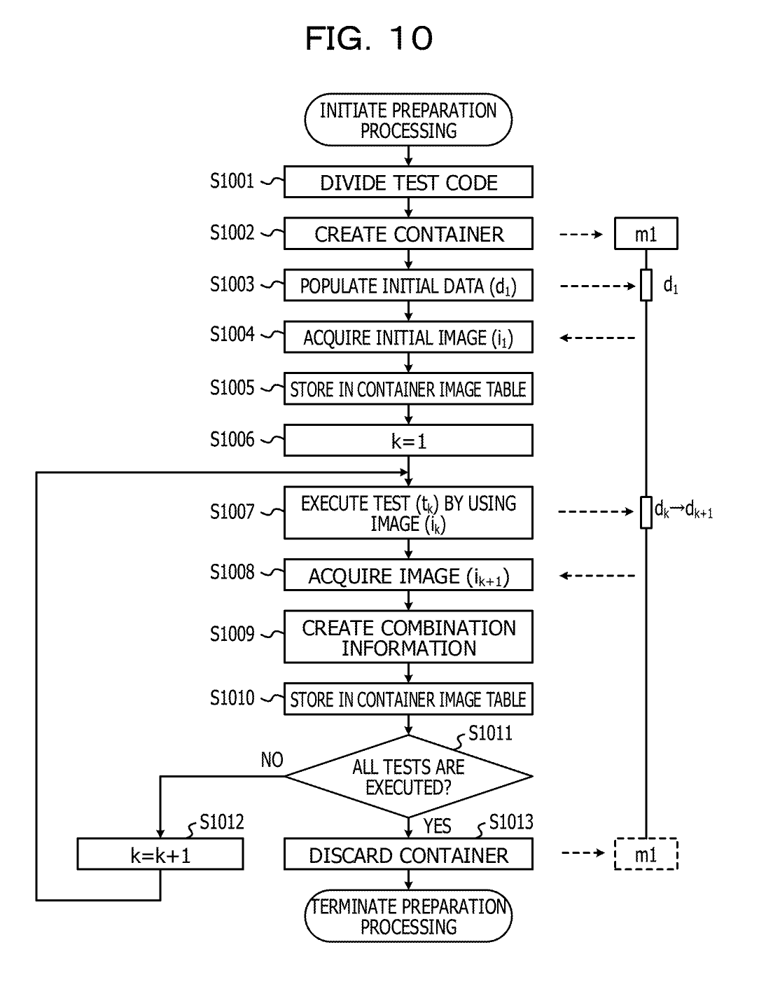

Next, details of the preparation processing (step S911) included in the verification processing in the verification system 300 will be described. FIG. 10 is a flowchart of the preparation processing. Note that, in order to clearly explain, processing operations in respective processes in the flowchart and an operation of a container (m1) are illustrated in FIG. 10 while being associated with each other.

In a step S1001, the test code dividing unit 810 receives a verification instruction transmitted by the terminal 310 and extracts a test set included in the verification instruction. In addition, the test code dividing unit 810 divides the extracted test set into individual tests.

In a step S1002, the container creating unit 820 creates the container m1. In a step S1003, the test execution unit 830 populates initial data (d₁) included in the test set into the container m1 created by the container creating unit 820. From this, in the container m1, an initial image (i₁) including the initial data (d₁) is created.

In a step S1004, the test execution unit 830 acquires the initial image (i₁) created by the container m1.

In a step S1005, the test execution unit 830 stores, in the container image table 700, the acquired initial image and the image ID=“i₁” of the initial image while associating the acquired initial image and the image ID=“i₁” of the initial image with each other.

In a step S1006, the test execution unit 830 substitutes an initial value=1 into a test counter k.

In a step S1007, using an image identified by an image ID=“iₖ”, the test execution unit 830 executes a test identified by a test ID=“tₖ”. The container m1 executes a test identified by, for example, a test ID=“t₁” from among individual tests obtained by the test code dividing unit 810 dividing the test set in the step S1001. At this time, the image identified by the image ID=“i₁” and acquired in the step S1004 is used as an input image.

The container m1 executes the test identified by the test ID=“t₁”, and accordingly, the container m1 creates an output image including output data d₂ from the input image including the input data d₁.

In a step S1008, the test execution unit 830 acquires the output image created by the container m1 (an image identified by an image ID=“i₂”).

In a step S1009, the combination information creating and updating unit 840 creates combination information by using the image ID=“i₁” of the image acquired in the step S1004 and the image ID=“i₂” of the image acquired in the step S1008. In addition, the created combination information is stored in the combination information table 600.

In a step S1010, the test execution unit 830 stores, in the container image table 700, the image acquired in the step S1008 and the image ID=“i₂” of the image while associating the image acquired in the step S1008 and the image ID=“i₂” of the image with each other.

In a step S1011, for all the tests obtained by the test code dividing unit 810 dividing the test set in the step S1001, the test execution unit 830 determines whether or not pieces of combination information are created. In a case where, in the step S1011, it is determined that there is a test in which the combination information is not created, the processing proceeds to a step S1012.

In the step S1012, the test execution unit 830 increments the test counter k and returns to the step S1007. Here, it is assumed that the test counter k=2 is satisfied.

In the step S1007, the test execution unit 830 executes a test identified by a test ID=“t₂”, by using the image identified by the image ID=“i₂”. The image identified by the image ID=“i₂” is stored in the container image table 700 in the container image storage unit 323. Therefore, in the test execution unit 830, the image identified by the image ID=“i₂” is read from the container image table 700 in the container image storage unit 323 and is input, as an input image, to the container m1.

The container m1 executes the test identified by the test ID=“t₂”. Accordingly, the container m1 creates an output image including output data d₃ from the input image including input data d₂.

In the step S1008, the test execution unit 830 acquires the output image created by the container m1 (an image identified by an image ID=“i₃”).

In the step S1009, the combination information creating and updating unit 840 creates combination information. The combination information creating and updating unit 840 utilizes the image ID=“i₂” of the image acquired in the step S1008 in a state of the test counter k=1 and the image ID=“i₃” of the image acquired in the step S1008 in a state of the test counter k=2. Note that the created combination information is stored in the combination information table 600.

In the step S1010, the test execution unit 830 stores, in the container image table 700, the image acquired in the step S1008 in a state of the test counter k=2 and the image ID=“i₃” of the image while associating the image acquired in the step S1008 in a state of the test counter k=2 and the image ID=“i₃” of the image with each other.

In the step S1011, for all the tests obtained by the test code dividing unit 810 dividing the test set in the step S1001, the test execution unit 830 determines again whether or not pieces of combination information are created. In a case where, in the step S1011, it is determined that there is a test in which the combination information is not created, the processing proceeds to the step S1012, and after incrementing the test counter k, the processing operations from the step S1007 to the step S1010 are repeated.

On the other hand, in a case where, in the step S1011, it is determined that the pieces of combination information are created for all the tests, the processing proceeds to a step S1013. In the step S1013, the container discarding unit 850 discards the container m1 and terminates the preparation processing.

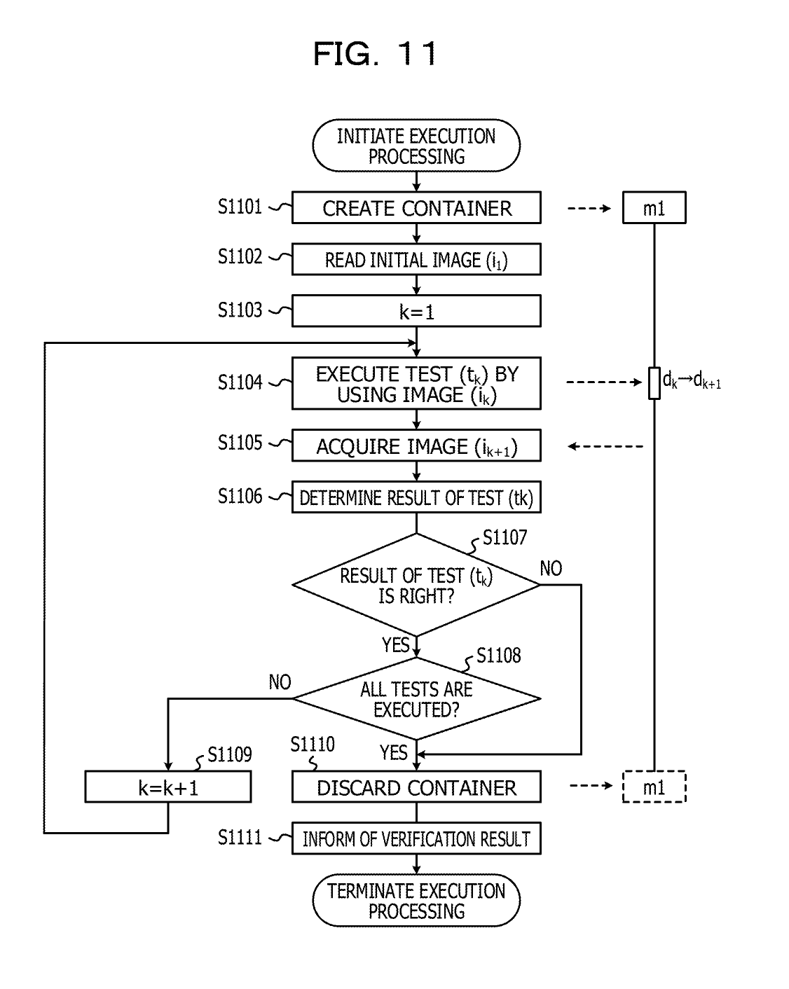

Next, details of the execution processing (step S912) included in the verification processing in the verification system 300 will be described. FIG. 11 is a flowchart of the execution processing. Note that, in order to clearly explain, processing operations in respective processes in the flowchart and an operation of the container (m1) are illustrated in FIG. 11 while being associated with each other.

In a step S1101, the container creating unit 820 creates the container m1. In a step S1102, the test execution unit 830 reads the initial image identified by the image ID=“i₁”, from the container image table 700 in the container image storage unit 323.

In the step S1102, the test execution unit 830 substitutes the initial value=1 into the test counter k.

In a step S1104, using an image identified by the image ID=“iₖ”, the test execution unit 830 executes a test identified by the test ID=“tₖ”. The container m1 executes the test identified by, for example, the test ID=“t₁” from among individual tests obtained in the preparation processing. At this time, the initial image identified by the image ID=“i₁” and read in the step S1102 is used as an input image.

The container m1 executes the test identified by the test ID=“t₁”, and accordingly, the container m1 creates an output image including the output data d₂ from the input image including the input data d₁.

In a step S1105, the test execution unit 830 acquires the output image created by the container m1 (an image identified by the image ID=“i₂”).

In a step S1106, the test execution unit 830 extracts the output data d₂ included in the acquired output image and determines whether or not the output data d₂ is right as output data in a case of executing the test identified by the test ID=“t₁”.

In a case where, in a step S1107, the test execution unit 830 determines that the output data d₂ is not right as the output data, the processing proceeds to a step S1110. In the step S1110, the container discarding unit 850 discards the container m1. Furthermore, in a step S1111, the test execution unit 830 informs, as a verification result, the terminal 310 that wrong output data is output in the test identified by the test ID=“t₁”, and the test execution unit 830 terminates the execution processing.

On the other hand, in a case where, in the step S1107, the test execution unit 830 determines that the output data d₂ is right as the output data, the processing proceeds to a step S1108. In the step S1108, the test execution unit 830 determines whether or not all the tests obtained in the preparation processing are executed.

In a case where, in the step S1108, it is determined that there is a test not executed, the processing proceeds to a step S1109, and after incrementing the test counter k, the processing returns to the step S1104. Here, it is assumed that the test counter k=2 is satisfied.

In the step S1104, the test execution unit 830 executes the test identified by the test ID=“t₂” by using the image identified by the image ID=“i₂”. The image identified by the image ID=“i₂” is stored in the container image table 700 in the container image storage unit 323. Therefore, the test execution unit 830 reads, from the container image table 700 in the container image storage unit 323, the image identified by the image ID=“i₂” and inputs the read image, as an input image, to the container m1.

The container m1 executes the test identified by the test ID=“t₂”. Accordingly, the container m1 creates an output image including the output data d₃ from the input image including the input data d₂.

In the step S1105, the test execution unit 830 acquires the output image created by the container m1 (an image identified by the image ID=“i₃”).

In the step S1106, the test execution unit 830 extracts the output data d₃ included in the acquired output image and determines whether or not the extracted output data d₃ is right as output data in a case of executing the test identified by the test ID=“t₂”.

In a case where, in the step S1107, the test execution unit 830 determines that the output data d₃ is right as the output data, the processing proceeds to the step S1108, and the processing operations from the step S1104 to the step S1107 are repeated until execution of all the tests is completed.

On the other hand, in a case where, in the step S1108, it is determined that all the tests are executed, the processing proceeds to the step S1110. In the step S1110, the container discarding unit 850 discards the container m1. Furthermore, in the step S1111, the test execution unit 830 informs, as a verification result, the terminal 310 that right pieces of output data are output for all the tests, and the test execution unit 830 terminates the execution processing.

In this way, the verification execution unit 321 executes processing until it is determined that output data is not right or until all the tests are completed, and if the processing finishes, the verification execution unit 321 transmits a verification result to the terminal 310.

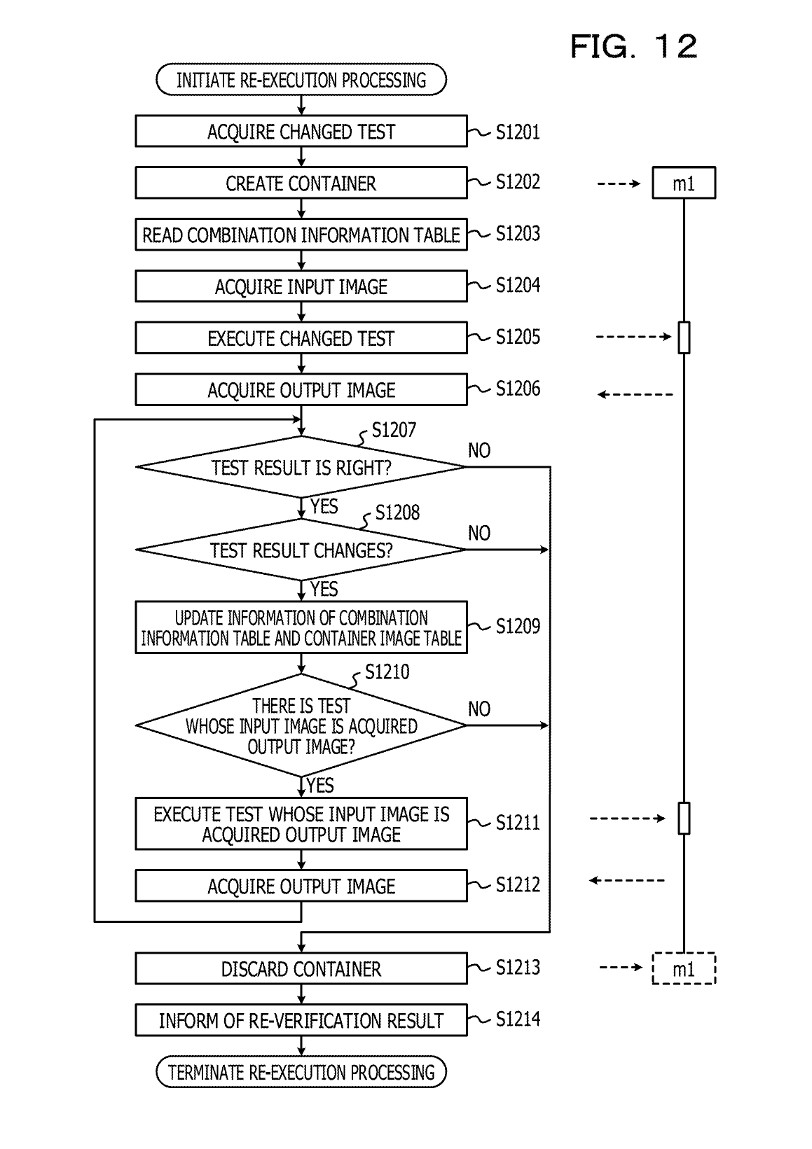

Next, details of the re-execution processing (step S913) included in the verification processing in the verification system 300 will be described. FIG. 12 is a flowchart of the re-execution processing. Note that, in order to clearly explain, processing operations in respective processes in the flowchart and an operation of the container (m1) are illustrated in FIG. 12 while being associated with each other.

In a step S1201, the test execution unit 830 receives a re-verification instruction transmitted by the terminal 310 and extracts a test (a changed test) included in the re-verification instruction.

In a step S1202, the container creating unit 820 creates the container m1. In a step S1203, the test execution unit 830 reads, from the combination information storage unit 322, the combination information table 600 of an extracted test ID.

In the step S1204, the test execution unit 830 references the combination information table 600 read in the step S1202. From this, the image ID of an input image, stored while being associated with the test ID of the test extracted in the step S1201, is read. Furthermore, the test execution unit 830 acquires, as an input image, an image stored in the container image table 700 in the container image storage unit 323 while being associated with the read image ID of an input image.

In a step S1205, using the input image acquired in the step S1204, the test execution unit 830 executes the test (the changed test) extracted in the step S1201.

Using, for example, the input image acquired in the step S1204, the container m1 executes the changed test. The container m1 executes the changed test, and accordingly the container m1 creates an output image from the input image.

In a step S1206, the test execution unit 830 acquires the output image created by the container m1 and extracts output data included in the output image.

In a step S1207, the test execution unit 830 determines whether or not the extracted output data is right. In a case where, in the step S1207, the test execution unit 830 determines that the extracted output data is not right as output data, the processing proceeds to a step S1213. In the step S1213, the container discarding unit 850 discards the container m1. Furthermore, in a step S1214, the test execution unit 830 informs, as a re-verification result, the terminal 310 that wrong output data is output, and the test execution unit 830 terminates the re-execution processing.

On the other hand, in a case where, in the step S1207, the test execution unit 830 determines that the extracted output data is right as output data, the processing proceeds to a step S1208. In the step S1208, the test execution unit 830 determines whether or not a test result changes. Note that whether or not the test result changes is determined in accordance with the following procedure.

First, the test execution unit 830 references the combination information table 600, based on the test ID of the test executed in the step S1205, and acquires the image ID of a corresponding output image. Next, the test execution unit 830 references the container image table 700, based on the acquired image ID of the output image, reads a corresponding image, and acquires output data. In addition, the test execution unit 830 compares the acquired output data and the output data extracted in the step S1206 with each other, and if the two are equal to each other, the test execution unit 830 determines that the test result does not change. On the other hand, if the two are different from each other, the test execution unit 830 determines that the test result changes.

In a case where, in the step S1208, it is determined that the test result does not change, the processing proceeds to the step S1213, and the container discarding unit 850 discards the container m1, and in the step S1214, the test execution unit 830 informs the terminal 310 of a re-verification result. Here, as the re-verification result, the terminal 310 is informed that the changed test properly operates.

On the other hand, in a case where, in the step S1208, it is determined that the test result changes, the processing proceeds to a step S1209. In the step S1209, using the image ID of the output image acquired in the step S1206, the combination information creating and updating unit 840 updates combination information. Using the image ID of the output image acquired in the step S1206, the combination information creating and updating unit 840 rewrites, for example, an “output image ID” stored while being associated with the test ID of the changed test.

Furthermore, the test execution unit 830 adds, to the container image table 700, the output image acquired in the step S1206 and the image ID of the output image while associating the output image acquired in the step S1206 and the image ID of the output image with each other.

In a step S1210, the test execution unit 830 determines whether or not there is a test whose input image is an output image stored in the combination information table 600 while being associated with the test ID of the test executed in the step S1205. Using, for example, the image ID of the output image stored in the combination information table 600 while being associated with the test ID of the test executed in the step S1205, the test execution unit 830 searches within the “input image ID” of the combination information table 600. If, as a result of the search, the image ID of the output image is stored in the “input image ID”, in the step S1210 the test execution unit 830 determines that there is a test whose input image is the output image, and the processing proceeds to a step S1211. On the other hand, if the image ID of the output image is not stored in the “input image ID”, in the step S1210 the test execution unit 830 determines that there is no test whose input image is the output image, and the processing proceeds to a step S1213.

In the step S1213, the container discarding unit 850 discards the container m1, and in the step S1214, the test execution unit 830 informs the terminal 310 of a re-verification result. Here, the test execution unit 830 informs, as the re-verification result, the terminal 310 that the changed test properly operates.

In the step S1211, the test execution unit 830 executes the test to

which the output image acquired in the step S1206 is input as an input image. The output image acquired in the step S1206 is already stored in the container image table 700. Therefore, in the test execution unit 830, an image stored in the container image table 700 is read, and the read image is input, as an input image, to the container m1. By executing the test, the container m1 creates an output image.

In a step S1212, the test execution unit 830 acquires the output image created by the container m1 and extracts output data included in the output image. After that, the processing returns to the step S1207.

In the step S1207, the test execution unit 830 determines whether or not the output data extracted in the step S1212 is right. In a case where, in the step S1207, the test execution unit 830 determines that the extracted output data is not right as output data, the processing proceeds to the step S1213 and the step S1214. In this case, in the step S1214, the test execution unit 830 informs, as a re-verification result, the terminal 310 that wrong output data is output in the test executed in the step S1211, and the test execution unit 830 terminates the re-execution processing.

On the other hand, in a case where, in the step S1207, the test execution unit 830 determines that the extracted output data is right as output data, the processing proceeds to the step S1208. In the step S1208, the test execution unit 830 determines whether or not a test result changes. Note that whether or not the test result changes is determined in accordance with the following procedure.

Based on the test ID of the test executed in the step S1211, the combination information table 600 is referenced, and the image ID of a corresponding output image is acquired.

Based on the acquired image ID of the output image, the container image table 700 is referenced, and a corresponding image is read, and output data is acquired.

The acquired output data and the output data extracted in the step S1212 are compared with each other, and if the two are equal to each other, it is determined that a test result does not change. On the other hand, if the two are different from each other, it is determined that the test result changes.

Since the subsequent processing operations from the step S1208 have already been described, the description thereof will be omitted here.

In this way, the verification execution unit 321 executes a test until it is determined that output data is not right, until it is determined that a test result does not change, or until it is determined that there is no test whose input image is an acquired output image. In addition, if the test finishes, the verification execution unit 321 informs the terminal 310 of a re-verification result.

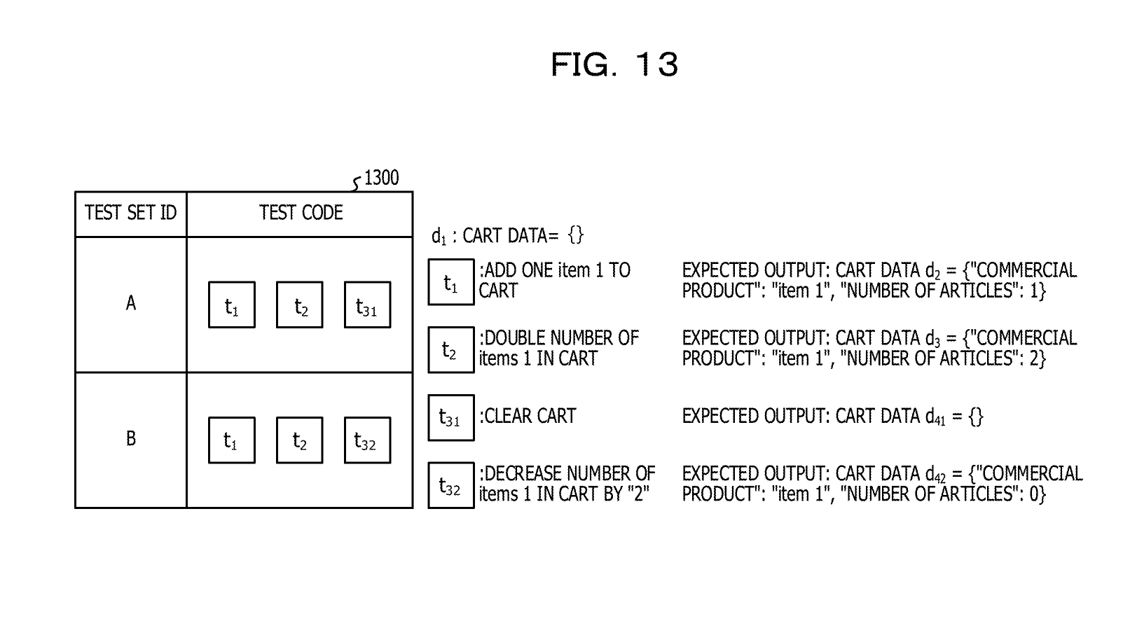

Next, an example of the verification processing in the verification system 300 will be further described using FIG. 13 and other drawings.

FIG. 13 illustrates an example of a test set table. Test sets identified by test set IDs=“A” and “B” stored in a test set table 1300 illustrated in FIG. 13 include a test relating to an operation of a user in an electronic commerce (eC) site.

As illustrated in FIG. 13, the test set of the test set ID=“A” includes tests identified by test IDs=“t₁”, “t₂”, and “t₃₁”. The test identified by the test ID=“t₁” is an operation for adding one item 1 to a cart. Output data at the time of executing the test identified by the test ID=“t₁” is cart data d₂={“commercial product”: “item 1”, “number of articles”: 1}.

In addition, the test identified by the test ID=“t₂” is an operation for doubling the number of the items 1 in the cart. Output data at the time of executing the test identified by the test ID=“t₂” is cart data d₃={“commercial product”: “item 1”, “number of articles”: 2}.

In addition, the test identified by the test ID=“t₃₁” is an operation for clearing the cart. Output data at the time of executing the test identified by the test ID=“t₃₁” is cart data d₄₁={}.

On the other hand, the test set of the test set ID=“B” includes tests identified by test IDs=“t₁”, “t₂”, and “t₃₂”. The tests identified by the tests ID=“t₁” and “t₂” are as described above. The test identified by the test ID=“t₃₂” is an operation for decreasing the number of the items 1 in the cart by “2”. Output data at the time of executing the test identified by the test ID=“t₃₂” is cart data d₄₂={“commercial product”: “item 1”, “number of articles”: 0}.

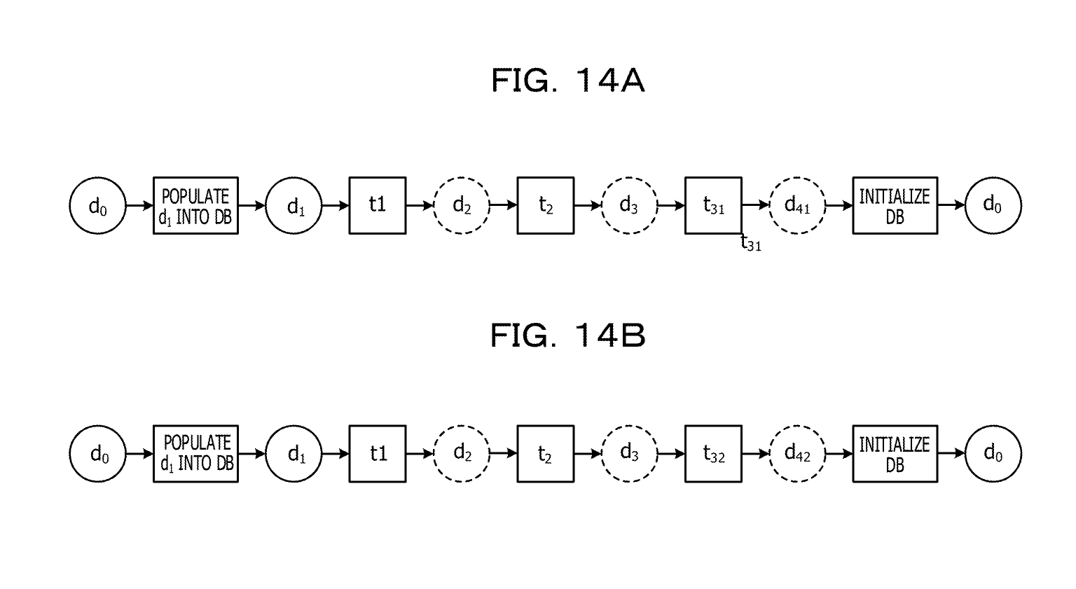

If being illustrated while manifesting the input data and the output data, the test sets illustrated in FIG. 13 are as illustrated in FIGS. 14A and 14B. FIGS. 14A and 14B each illustrate a relationship between individual tests included in a test set. Among these, FIG. 14A illustrates a relationship between the individual tests included in the test set identified by the test set ID=“A”. FIG. 14B illustrates a relationship between the individual tests included in the test set identified by the test set ID=“B”.

In the example of FIG. 14A, the test identified by the test ID=“t₁” has input data=d₁ and output data=d₂. In addition, the test identified by the test ID=“t₂” has input data=d₂ and output data=d₃. Furthermore, the test identified by the test ID=“t₃₁” has input data=d₃ and output data=d₄₁.

In addition, in the example of FIG. 14B, the test identified by the test ID=“t₃₂” has the input data=d₃ and output data=d₄₂.

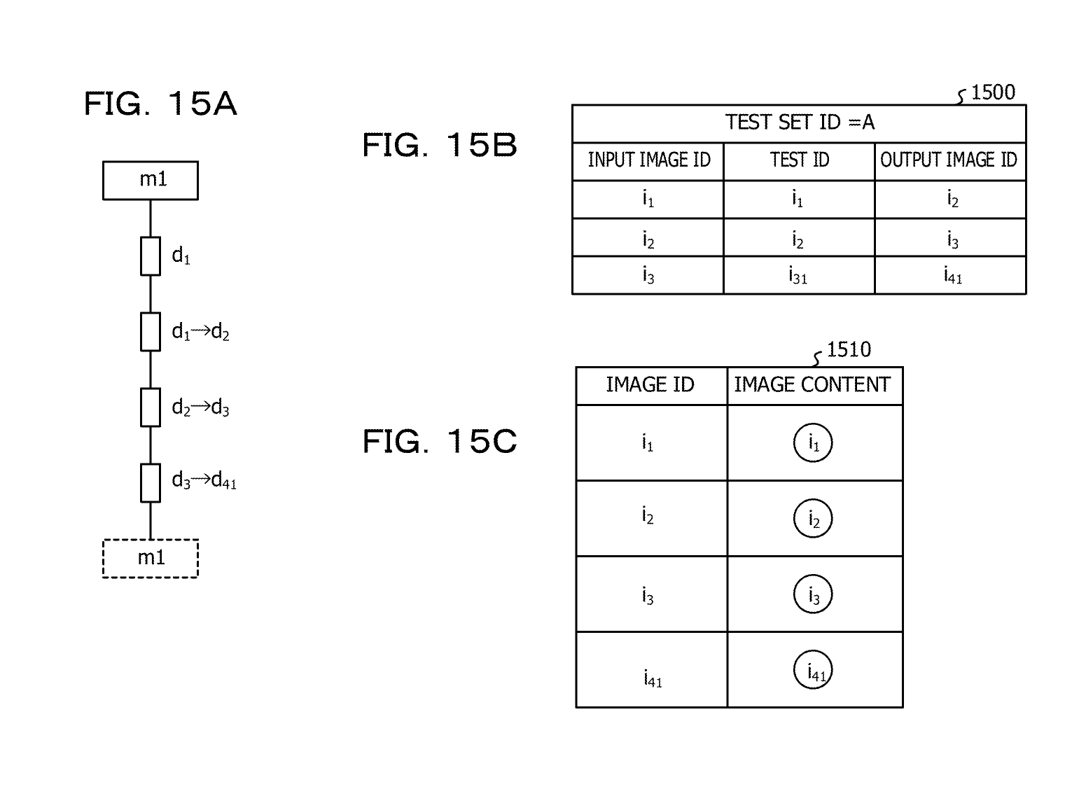

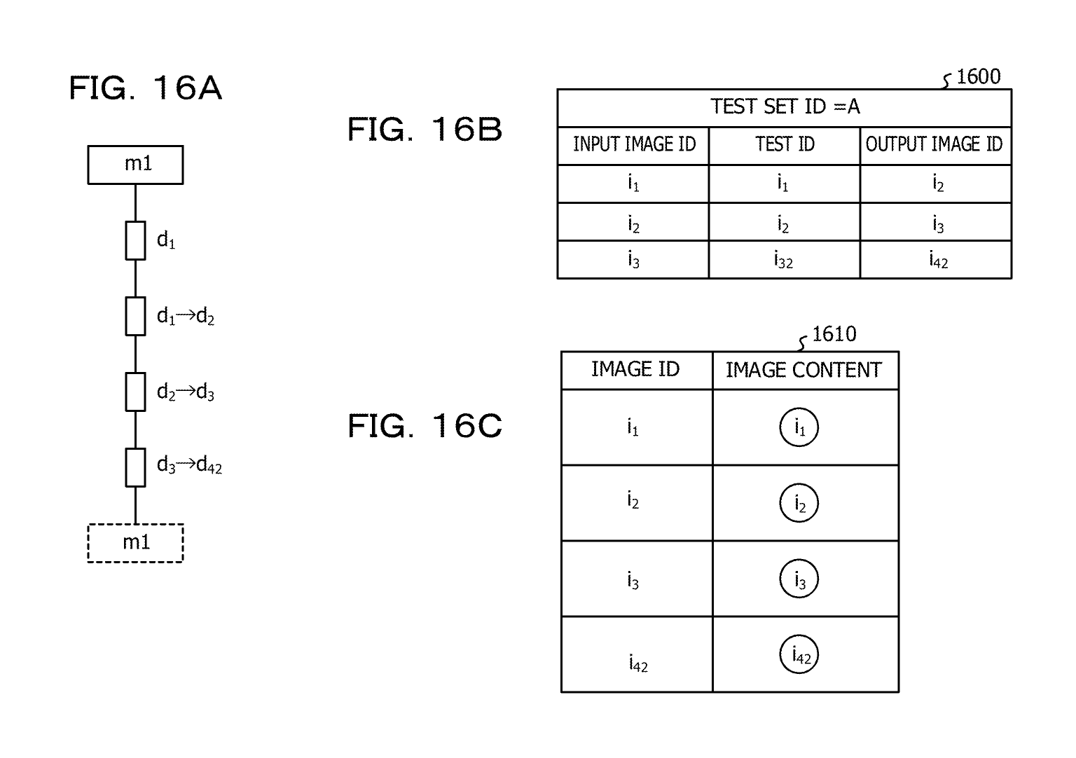

In a case where the individual tests included in the test sets have relationships illustrated in FIGS. 14A and 14B, the verification device 320 executes the preparation processing, thereby creating a combination information table 1500, a container image table 1510, a combination information table 1600, and a container image table 1610 illustrated in FIGS. 15A, 15B, and 15C and FIGS. 16A, 16B, and 16C.

FIGS. 15A, 15B, and 15C illustrate examples of a combination information table and a container image table. The preparation processing is executed for the test set identified by the test set ID=“A”, thereby creating the combination information table 1500 and the container image table 1510 illustrated in FIGS. 15A, 15B, and 15C. Note that FIG. 15A illustrates an operation of a container corresponding to the test set identified by the test set ID=“A”.

The test set identified by the test set ID=“A” has the initial data=d₁. Therefore, as illustrated in FIG. 15A, in the test execution unit 830, first the initial data=d₁ is populated into the created container m1, and an input image identified by an input image ID=“i₁” is acquired.

Subsequently, using the input image identified by the input image ID=“i₁”, the container m1 executes the test identified by the test ID=“t₁”. From this, the container m1 creates an output image including the output data d₂. Note that here it is assumed that the image ID of the created output image is “i₂”.

The combination information creating and updating unit 840 stores “i₁” in the “input image ID” of the combination information table 1500, stores “t₁” in the “test ID” thereof, and stores “i₂” in the “output image ID” thereof (see FIG. 15B).

In addition, the test execution unit 830 stores “i₁” and “i₂” in the “image ID” of the container image table 1510 and stores, in the “image content” thereof, the images identified by the image IDs=“i₁” and “i₂” (see FIG. 15C).

After that, in the same way, the container m1 executes, based on input images, individual tests and creates output images, thereby creating the combination information table 1500 and the container image table 1510.

In addition, FIGS. 16A, 16B, and 16C illustrate other examples of the combination information table and the container image table. The preparation processing is executed for the test set identified by the test set ID=“B”, thereby creating the combination information table 1600 and the container image table 1610 illustrated in FIGS. 16A, 16B, and 16C. Note that FIG. 16A illustrates an operation of a container corresponding to the test set identified by the test set ID=“B”.

As illustrated in FIG. 16A, using the input image identified by the input images ID=“i₁” and “i₂”, the container m1 executes the tests identified by the test IDs=“t₁” and “t₂”. Note that since the combination information and the images created in a case of executing the tests identified by the test IDs=“t₁” and “t₂” are already described using FIGS. 15A, 15B, and 15C, the descriptions thereof will be omitted.

If an output image identified by an output image ID=“i₃” is created by executing the test identified by the test ID=“t₂”, the test execution unit 830 inputs, to the container m1, the output image identified by the output image ID=“i₃”.

Based on the image identified by the image ID=“i₃”, the container m1 executes the test identified by the test ID=“t₃₂”. From this, the container m1 creates an output image including the output data d₄₂. Note that here it is assumed that the image ID of the created output image is “i₄₂”.

The combination information creating and updating unit 840 stores “i₃” in the “input image ID” of the combination information table 1600, stores “t₃₂” in the “test ID” thereof, and stores “i₄₂” in the “output image ID” thereof (see FIG. 16B).

In addition, the test execution unit 830 stores “i₄₂” in the “image ID” of the container image table 1610 and stores, in the “image content” thereof, the images identified by the image ID=“i₄₂” (see FIG. 16C).

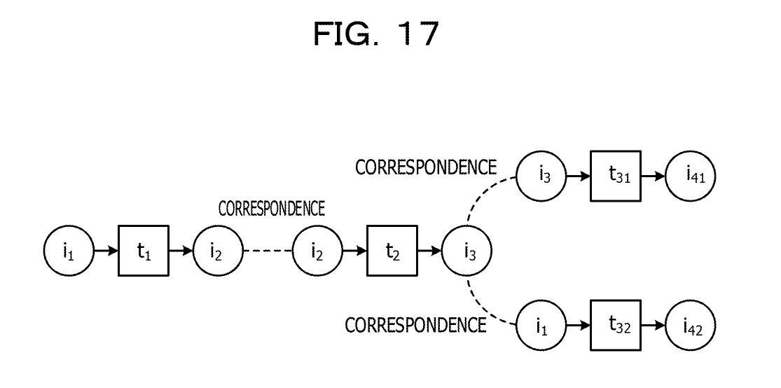

Here, a schematic illustration in which the combination information table 1500 in FIG. 15B and the combination information table 1600 in FIG. 16B are collected is as illustrated in FIG. 17. FIG. 17 illustrates a relationship between tests and images.

As illustrated in FIG. 17, if the test identified by the test ID=“t₁” is executed while defining, as an input image, the image identified by the image ID=“i₁”, the image identified by the image ID=“i₂” is output.

In the same way, if the test identified by the test ID=“t₂” is executed while defining, as an input image, the image identified by the image ID=“i₂”, the image identified by the image ID=“i₃” is output.

On the other hand, the image identified by the image ID=“i₃” is input, as input images, in the tests identified by the test IDs=“t₃₁” and “t₃₂”. In addition, the respective tests are executed, thereby outputting the images identified by the image IDs=“i₄₁” and “i₄₂”.

Note that the image identified by the image ID=“i₂” includes the cart data d₂={“commercial product”: “item 1”, “number of articles”: 1}. In addition, the image identified by the image ID=“i₃” includes the cart data d₃={“commercial product”: “item 1”, “number of articles”: 2}. In addition, the image identified by the image ID=“i₄₁” includes the cart data d₄₁={}. Furthermore, the image identified by the image ID=“i₄₂” includes the cart data d₄₂={“commercial product”: “item 1”, “number of articles”: 0}.

Here, the re-execution processing in a case where, using a function of the test set creating unit 311, the user of the terminal 310 changes the test identified by the test ID=“t₁” and included in the test set ID=“A” will be described.

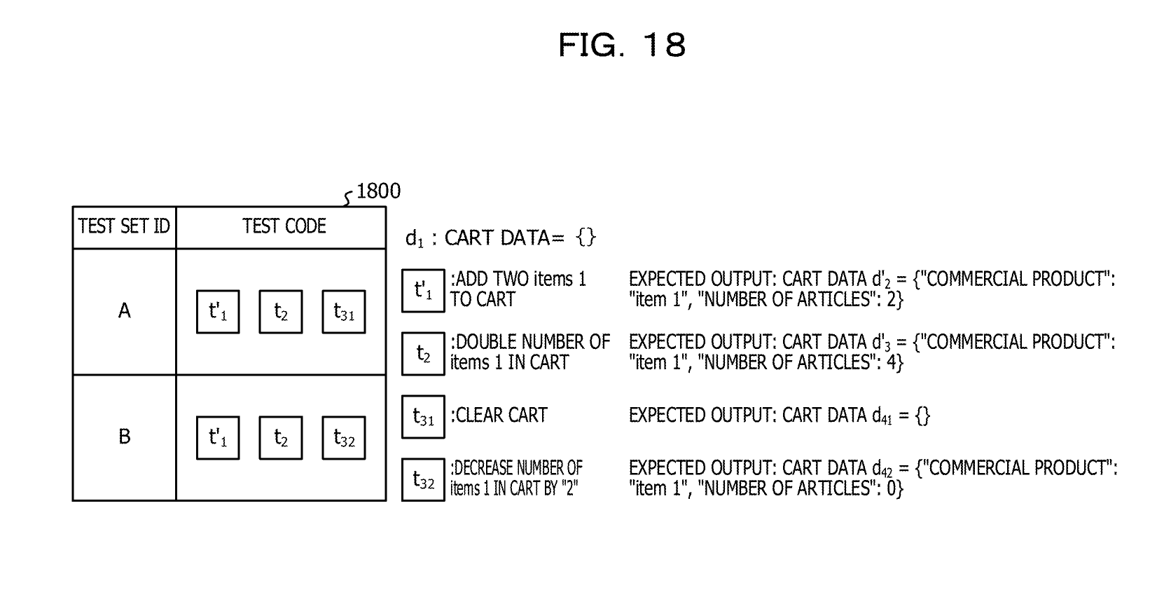

FIG. 18 illustrates an example of a changed test set. It is assumed that, as illustrated in FIG. 18, the user of the terminal 310 changes the test identified by the test ID=“t₁” included in the test set ID=“A”.

While the test identified by the test ID=“t₁” before the change is an operation for adding one item 1 to the cart, a test identified by a test ID=“t′₁” after the change is an operation for adding, for example, two items 1 to the cart. Therefore, it is assumed that the user of the terminal 310 changes, to cart data d′₂ ={“commercial product”: “item 1”, “number of articles”: 2}, output data in a case of executing the test identified by the test ID=“t′₁”. In addition, it is assumed that, along with this, the user of the terminal 310 changes, to cart data d′₃={“commercial product”: “item 1”, “number of articles”: 4}, output data in a case of executing the test identified by the test ID=“t₂”.

If a re-verification instruction including the test set ID=“A” serving as the test after the change (the test identified by the test ID=“t′₁”) and the test set ID=“B” is transmitted by the terminal 310, the verification execution unit 321 executes the re-execution processing.

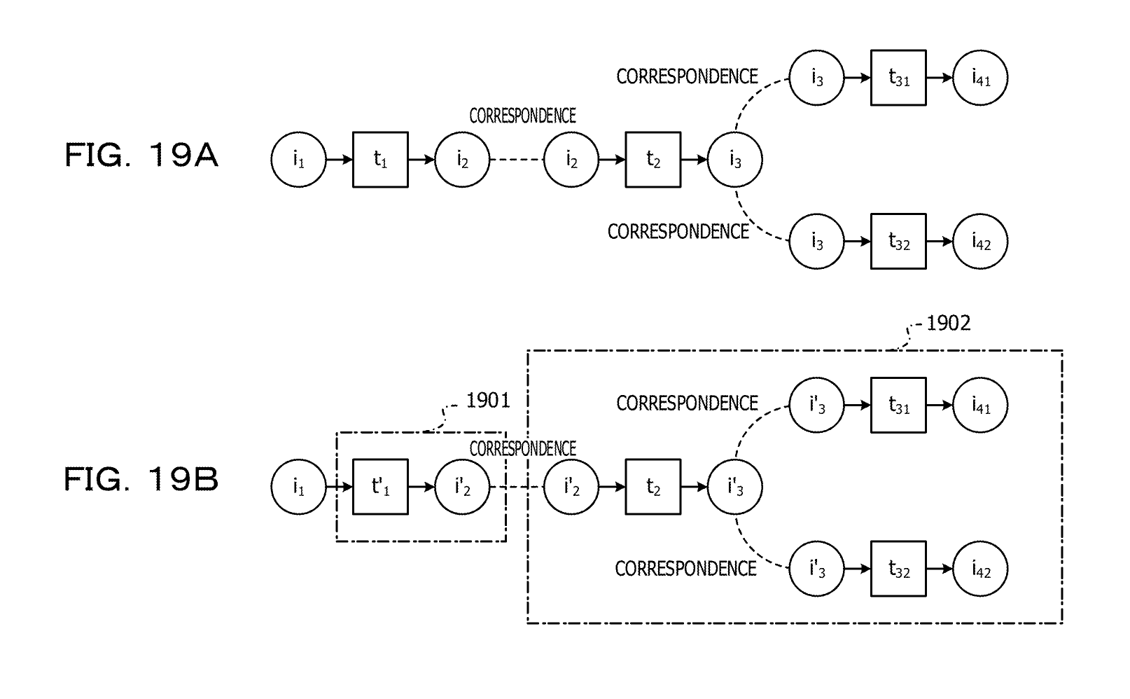

If the re-execution processing is executed, the test execution unit 830 searches for a test to be re-executed in association with the change of the test. By searching, for example, the combination information tables 1500 and 1600, combination information including the test to be re-executed is extracted. Note that here, in order to clearly explain, an explanation will be provided using diagrams each illustrating a relationship between tests and images. FIGS. 19A and 19B are diagrams for contrasting relationships between tests and images before and after a change with each other.

In a case where, as illustrated in FIGS. 19A and 19B, the test identified by the test ID=“t₁” is changed to the test identified by the test ID=“t′₁”, an output image is changed. The image identified by the image ID=“i₂” is changed to, for example, an image identified by an image ID=“i′₂”. In other words, processing surrounded by a dashed-dotted line 1901 is changed.

In addition, as illustrated in FIG. 19B, in a case where the output image (the image ID=“i′₂”) is changed, the test to which the output image is input as an input image and that is identified by the test ID=“t₂” is influenced. In addition, the output image of the test identified by the test ID=“t₂” is influenced. Furthermore, the tests to which the output image of the test identified by the test ID=“t₂” is input as input images and that are identified by the test IDs=“t₃₁” and “t₃₂” are influenced. In other words, processing surrounded by a dashed-dotted line 1902 is influenced.

Accordingly, in the test execution unit 830, the test IDs=“t₂”, “t₃₁”, and “t₃₂” are extracted as tests to be re-executed in association with the change of the test identified by the test ID=“t′₁”.

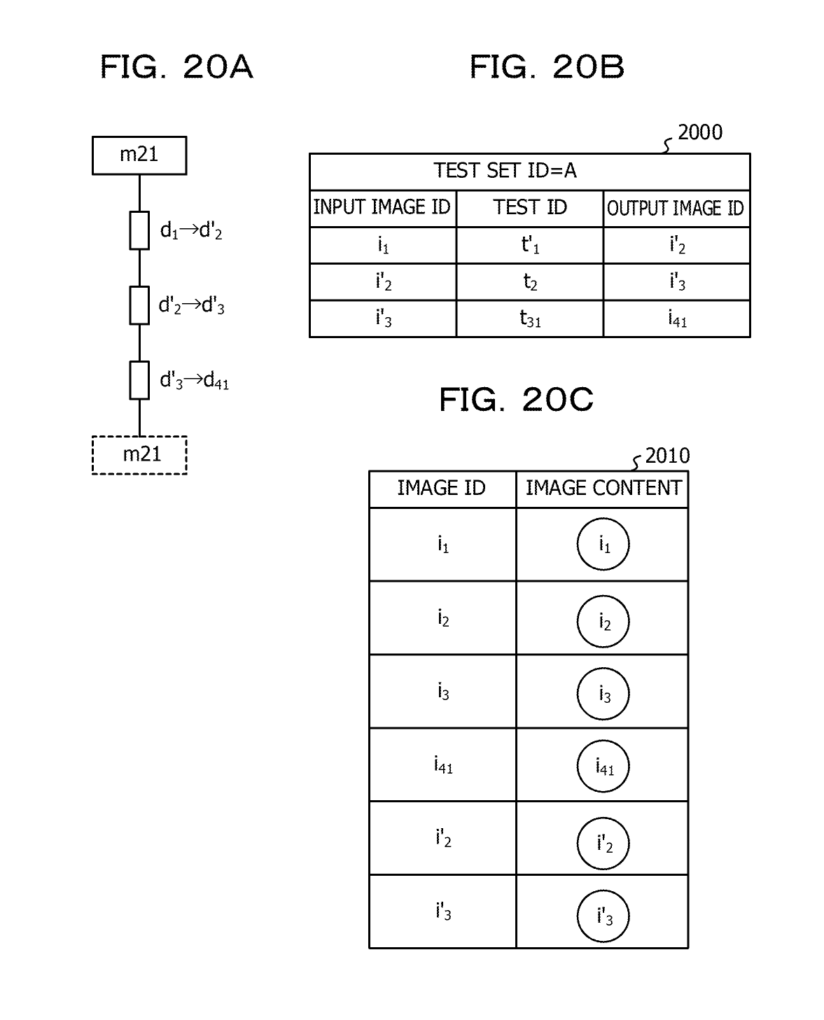

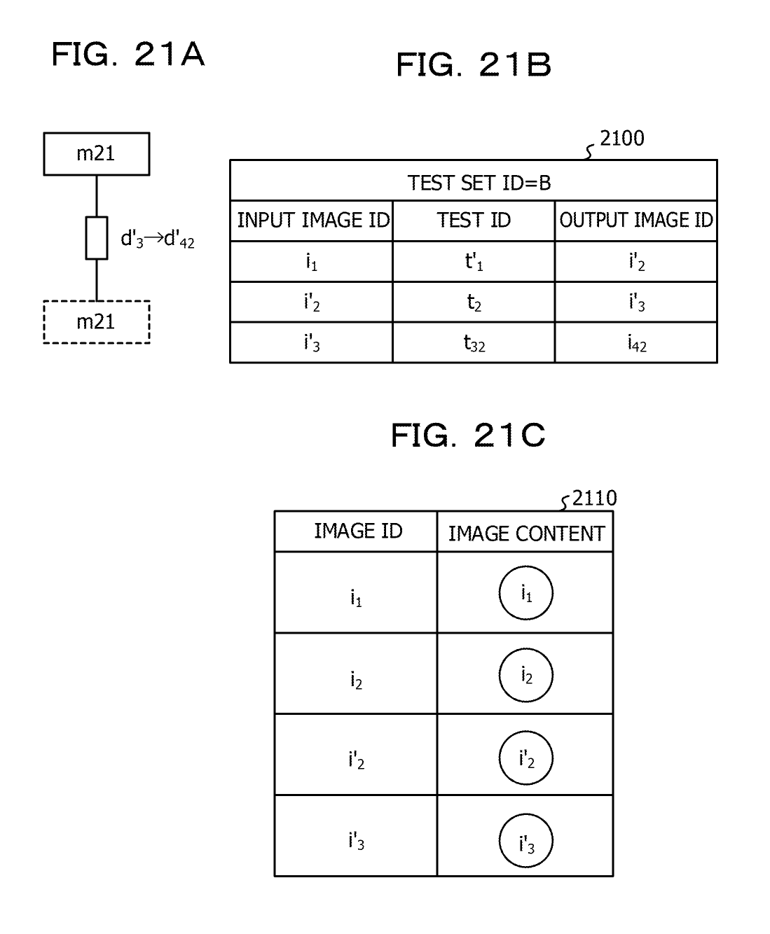

Subsequently, re-execution of tests in the re-execution processing will be described using FIGS. 20A, 20B, and 20C and FIGS. 21A, 21B, and 21C. FIGS. 20A, 20B, and 20C illustrate other examples of the combination information table and the container image table, created by executing the re-execution processing. A combination information table 2000 and a container image table 2010 illustrated in FIGS. 20A, 20B, and 20C are created in a case of executing the re-execution processing for the test set of the test set ID=“A”. Note that FIG. 20A illustrates an operation of a container (m21) for the test set identified by the test set ID=“A”.

According to the combination information table 1500 created in the preparation processing, the input image of the test identified by the test ID=“t₁” is the image identified by the image ID=“i₁”. Therefore, the test execution unit 830 reads, from the container image table 1510, the image identified by the image ID=“i₁” and defines the read image as the input image of the test ID=“t′₁”. From this, the container m21 executes the test identified by the test ID=“t′₁” and creates an output image including output data d′₂. Note that here it is assumed that the image ID of the output image created at this time is “i′₂”.

The combination information creating and updating unit 840 updates, to “i′₂”, “i₂” in the “input image ID” of the combination information table 1500. In addition, the test execution unit 830 determines whether or not the output data d′₂ included in the image identified by the image ID=“i′₂” is right. Here, since the output data d′₂ is the cart data d′₂={“commercial product”: “item 1”, “number of articles”: 2}, the test execution unit 830 determines that the output data is right. Therefore, the test execution unit 830 stores “i′₂” in the “image ID” of the container image table 1510 and stores, in the “image content” thereof, the image identified by the image ID=“i′₂”.

The test execution unit 830 searches within the combination information table 1500 for combination information including a test whose input image corresponds to the image ID=“i₂” and extracts the combination information including the test ID=“t₂”. In addition, the test execution unit 830 causes the container m21 to execute the test identified by the test ID=“t₂”. The container m21 executes the test that is identified by the test ID=“t₂” and whose input image corresponds to the image ID=“i′₂”, thereby creating an output image including output data d′₃. Note that here it is assumed that the image ID of the output image created at this time is “i′₃”.

The combination information creating and updating unit 840 updates, to “i′₃”, “i₃” in the “output image ID” of the combination information table 1500. In addition, the test execution unit 830 determines whether or not the output data d′₃ included in the image identified by the image ID=“i′₃” is right. Here, since the output data d′₃ is the cart data d′₃={“commercial product”: “item 1”, “number of articles”: 4}, the test execution unit 830 determines that the output data is right. Therefore, the test execution unit 830 stores “i′₃” in the “image ID” of the container image table 1510 and stores, in the “image content” thereof, the image identified by the image ID=“i′₃”.

The test execution unit 830 searches within the combination information table 1500 for combination information including a test whose input image corresponds to the image ID=“i₃” and extracts the combination information including the test ID=“t₃₁”. In addition, the test execution unit 830 causes the container m21 to execute the test identified by the test ID=“t₃₁”. Based on the input image identified by the image ID=“i′₃”, the container m21 executes the test identified by the test ID=“t₃₁”, thereby creating an output image including output data d′₄₁.

Note that the output data d₄₁ output by the test identified by the test ID=“t₃₁” being executed is not changed. Therefore, the combination information creating and updating unit 840 does not change the image ID=“i₄₁” stored in the “output image ID” of the combination information table 1500.

In this way, the re-execution processing for the test set ID=“A” is executed. Accordingly, the combination information table 1500 illustrated in FIG. 15B is updated to the combination information table 2000 illustrated in FIG. 20B. In addition, the container image table 1510 illustrated in FIG. 15C is updated to the container image table 2010 illustrated in FIG. 20C.

FIGS. 21A, 21B, and 21C illustrate yet other examples of the combination information table and the container image table. A combination information table 2100 and a container image table 2110 illustrated in FIGS. 21A, 21B, and 21C are created by executing the re-execution processing for the test set of the test set ID=“B”. Note that FIG. 21A illustrates an operation of a container for the test set identified by the test set ID=“B”.

The output image IDs of the output images output by the container m21 executing the tests identified by the test IDs=“t′₁” and “t₂” are already stored in the combination information table 2000. In addition, the images identified by the output image IDs are already stored in the container image table 2010. Therefore, the descriptions thereof will be omitted.

The test execution unit 830 searches within the combination information table 1600 for combination information including a test whose input image corresponds to the image ID=“i₃” and extracts the combination information including the test ID=“t₃₂”. In addition, the test execution unit 830 causes the container m21 to execute the test identified by the test ID=“t₃₂”.

Based on the image identified by the image ID=“i′₃”, the container m21 executes the test identified by the test ID=“t₃₂”.

From this, the container m21 creates an output image including output data d′₄₂. Note that here it is assumed that the image ID of the output image created at this time is “i′₄₂”.

In addition, the test execution unit 830 determines whether or not the output data d′₄₂ included in the image identified by the image ID=“i′₄₂” is right. Here, the output data d′₄₂ is cart data d′₄₂={“commercial product”: “item 1”, “number of articles”: 2}. On the other hand, as illustrated in FIG. 18, an output expected as the output data d₄₂ is the cart data d₄₂={“commercial product”: “item 1”, “number of articles”: 0}.

Accordingly, the test execution unit 830 determines that a test result is not right, and the test execution unit 830 transmits, to the terminal 310, a re-verification result that the test result of the test identified by the test ID=“t₃₂” is not right.

Note that it is caused by changing the test identified by the test ID=“t₁” to the test identified by the test ID=“t′₁” that the test result of the test identified by the test ID=“t₃₂” is not right. The reason is that, from this, the number of the items 1 to be added to the cart is changed from “1” to “2” and the output data of the test identified by the test ID=“t₂” (in other words, the input data of the test identified by the test ID=“t₃₂”) becomes d′₃=4.

In other words, it is desirable that, at the time of changing the test identified by the test ID=“t₁” to the test identified by the test ID=“t′₁”, the user of the terminal 310 changes the output data (cart data d₄₂) of the test identified by the test ID=“t₃₂”. However, since the user of the terminal 310 does not change the cart data d₄₂, the re-verification result that the test result of the test identified by the test ID=“t₃₂” turns out to be given notice of. In this way, in the re-verification processing, it is possible to find out a test (or data) that is influenced by changing some tests included in a test set and that is not changed by the user of the terminal 310.

Note that the output image (the image identified by the image ID=“i′₄₂”) and the output image ID, in which a test result is determined as not right, are not stored in the combination information table 2100 and the container image table 2110 (FIGS. 21B and 21C).

The test execution unit 830 informs, as a re-verification result, the terminal 310 that the test result in the test identified by the test ID=“t₃₂” is not right. From this, it is possible for the user of the terminal 310 to recognize a test or data desired to be changed.

As is clear from the above-mentioned description, in the verification device in the present embodiment, a test set in which tests are to be successively executed is divided, and pieces of combination information of input data, tests, and output data are created. In addition, in a case where a test included in the test set is updated, thereby changing output data, a piece of combination information, in which output data stored in another piece of combination information including the test is defined as input data, is searched for. Furthermore, in a case where the input data stored in the searched combination information is updated and output data is changed by updating the input data, the output data is updated, and furthermore, a piece of combination information in which the updated output data is defined as input data is searched for. In addition, by repeating these, pieces of input data and pieces of output data stored in the combination information table are sequentially updated.

From this, according to the verification device in the present embodiment, it becomes possible to update combination information in response to a change of one test in a test set in which tests are to be successively executed, while executing an influenced test.

Note that while, in the above-mentioned description, a test is executed using a container, thereby acquiring an input image and an output image, the test may be executed using a VM, thereby acquiring the input image and the output image.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of verifying a set of tests in which the tests are successively executed, the method comprising:
creating, based on the set of tests, for each of the tests, combination information in which information for identifying the test, information for identifying input data, and information for identifying output data are associated with one another;
specifying, when a first test out of the tests is changed, second combination information in which information for identifying output data in first combination information relating to the first test is set as the information for identifying input data, the second combination information relating to a second test out of the tests;
updating, in the first combination information, the information for identifying the corresponding test to first information for identifying the changed first test;
updating, in the first combination information, the information for identifying the output data to second information for identifying output data output by verifying the changed first test; and
updating the second combination information, based on verifying the second test in which the information for identifying input data in the second combination information is set as the second information for identifying the output data in the updated first combination information.

2. The method according to claim 1, wherein
the specifying specifies the second combination information when it is determined that the output data output by verifying the changed first test is right.

3. The method according to claim 1, wherein
the specifying specifies the second combination information when the output data output by verifying the changed first test is different from output data output by executing verification of the first test before the change.

4. The method according to claim 1, wherein
the input data is an input image created by inputting information to a virtual machine.

5. The method according to claim 4, wherein
the output data is an output image output by executing the test, based on the input image.

6. The method according to claim 1, wherein
the verifying the set of tests includes a preparation phase for performing preparation before execution of the individual tests included in the set of tests, an execution phase for executing the individual tests, and a re-execution phase for re-executing a changed test.

7. The method according to claim 1, wherein
the set of tests is a test relating to a database into which the input data is populated, the database outputting, as the output data, a result of processing that utilizes the input data.

8. A non-transitory storage medium that stores a program for verifying a set of tests in which the tests are successively executed, the program causing a computer to execute a process, the process comprising:
creating, based on the set of tests, for each of the tests, combination information in which information for identifying the test, information for identifying input data, and information for identifying output data are associated with one another;
specifying, when a first test out of the tests is changed, second combination information in which information for identifying output data in first combination information relating to the first test is set as the information for identifying input data, the second combination information relating to a second test out of the tests;
updating, in the first combination information, the information for identifying the corresponding test to first information for identifying the changed first test;
updating, in the first combination information, the information for identifying the output data to second information for identifying output data output by verifying the changed first test; and
updating the second combination information, based on verifying the second test in which the information for identifying input data in the second combination information is set as the second information for identifying the output data in the updated first combination information.

9. The non-transitory storage medium according to claim 8, wherein
the specifying specifies the second combination information when it is determined that the output data output by verifying the changed first test is right.

10. The non-transitory storage medium according to claim 8, wherein
the specifying specifies the second combination information when the output data output by verifying the changed first test is different from output data output by executing verification of the first test before the change.

11. The non-transitory storage medium according to claim 8, wherein
the input data is an input image created by inputting information to a virtual machine.

12. The non-transitory storage medium according to claim 11, wherein
the output data is an output image output by executing the test, based on the input image.

13. The non-transitory storage medium according to claim 8, wherein
the verifying the set of tests includes a preparation phase for performing preparation before execution of the individual tests included in the set of tests, an execution phase for executing the individual tests, and a re-execution phase for re-executing a changed test.

14. The non-transitory storage medium according to claim 8, wherein
the set of tests is a test relating to a database into which the input data is populated, the database outputting, as the output data, a result of processing that utilizes the input data.

15. An apparatus comprising:
a memory; and
a processor coupled to the memory, wherein the processor is configured to execute a process based on executing of a program for verifying a set of tests in which the tests are successively executed, the process comprising:
creating, based on the set of tests, for each of the tests, combination information in which information for identifying the test, information for identifying input data, and information for identifying output data are associated with one another,
specifying, when a first test out of the tests is changed, second combination information in which information for identifying output data in first combination information relating to the first test is set as the information for identifying input data, the second combination information relating to a second test out of the tests,
updating, in the first combination information, the information for identifying the corresponding test to first information for identifying the changed first test,
updating, in the first combination information, the information for identifying the output data to second information for identifying output data output by verifying the changed first test, and
updating the second combination information, based on verifying the second test in which the information for identifying input data in the second combination information is set as the second information for identifying the output data in the updated first combination information.

16. The apparatus according to claim 15, wherein
the specifying specifies the second combination information when it is determined that the output data output by verifying the changed first test is right.

17. The apparatus according to claim 15, wherein
the specifying specifies the second combination information when the output data output by verifying the changed first test is different from output data output by executing verification of the first test before the change.

18. The apparatus according to claim 15, wherein
the input data is an input image created by inputting information to a virtual machine, and
the output data is an output image output by executing the test, based on the input image.

19. The apparatus according to claim 15, wherein
the verifying the set of tests includes a preparation phase for performing preparation before execution of the individual tests included in the set of tests, an execution phase for executing the individual tests, and a re-execution phase for re-executing a changed test.

20. The apparatus according to claim 15, wherein
the set of tests is a test relating to a database into which the input data is populated, the database outputting, as the output data, a result of processing that utilizes the input data.
